(19) United States
(12) Patent Application Publication
(10) Pub. No.: US 2020/0104789 A1
(43) Pub. Date: Apr. 2, 2020

(54) METHODS AND SYSTEMS FOR ORDERING FOOD FOR DELIVERY

(71) Applicant: Elliott Porco, Scarsdale, NY (US)

(72) Inventor: Elliott Porco, Scarsdale, NY (US)

(21) Appl. No.: 16/590,318

(22) Filed: Oct. 1, 2019

Related U.S. Application Data
(60) Provisional application No. 62/771,966, filed on Nov. 27, 2018.
(60) Provisional application No. 62/739,401, filed on Oct. 1, 2018.

(51) Int. Cl. G06Q 10/08; G06Q 30/06; G06F 3/048; G06Q 30/02

(52) U.S. Cl. CPC G06Q 10/087; G06Q 30/0633; G06Q 30/0603; G06Q 30/0641; G06Q 30/0217; G06F 3/048

(57) ABSTRACT

Computer-implemented methods for ordering food for delivery and systems for providing an interactive service and rewards for ordering food for delivery accessible by a user communication device. The methods comprise receiving a food order is prepared from the Entity's dedicated Kitchen(s) and or Partner's kitchen(s) comprising at least one menu item from a user communication device or a food delivery service over a communication network, wherein the at least one menu item is selected from a menu comprising at least one and/or two different pre-determined cuisine categories, and transmitting the received food order over a communication network to a kitchen or kitchens for preparation and packaging for subsequent acquisition by a delivery agent, wherein the kitchen or kitchens are configured to prepare the at least one menu item ordered from the menu comprising at least one and/or two different pre-determined cuisine categories.

### CROSS-REFERENCE TO RELATED APPLICATIONS

Pursuant to 35 U.S.C. § 119(e), this U.S. non-provisional patent application, filed pursuant to 35 U.S.C. § 111(a), claims the benefit of U.S. provisional patent application Ser. No. 62/739,401, filed Oct. 1, 2018, and U.S. provisional patent application Ser. No. 62/855,115, filed Nov. 27, 2018, both of which are incorporated herein by reference in their entireties.

### FIELD OF THE INVENTION

The present disclosure relates generally to methods for ordering food for delivery, as well as to systems for implementing such methods.

### BACKGROUND OF THE INVENTION

Interactive applications or websites through which a customer can conveniently order food items (e.g., pizza) from a restaurant for in-person delivery, such as to the customer's home or business, are known in the art. For example, the customer can access a website operated by a particular restaurant, select one or more food items from the menu offered by that restaurant, and place an order for its preparation and delivery.

In addition to such in-house restaurant delivery services, also now available are online food and/or beverage delivery services that provide a customer with the ability to order food and/or beverage items from a restaurant selected from a list of several for which the online delivery service will deliver the ordered items for a fee. To order and have delivered a food and/or beverage item through one of these online delivery services, the customer first accesses, e.g., by logging on to, the interactive application or website of a particular online delivery service. Then, based on the customer's geographic location (either entered by the customer or detected by the interactive application or website) and one or more search queries, a list of restaurant choices is populated. These listed restaurants have paid the online delivery service a fee to be included in this service. The fee is usually based on a percentage of sales. The percentage amount is usually dictated by where the order was generated from. Restaurants are locked in at a fixed percentage fee of sales using the online delivery food services, online order functionality and delivery service, i.e., the order and delivery was generated from the website of the delivery service, the fee could be 30% of sales. The customer selects a restaurant from among those listed and then selects one or more food and/or beverage items from the menu offered by the selected restaurant and available for delivery through the online delivery service. The customer then pays online for the order, including a delivery fee. Upon completion of the customer's order by the restaurant, the online delivery service typically sends an agent to the restaurant who acquires the ordered food and/or beverage items from the restaurant and then delivers them to the customer. The online delivery service takes their online order fee and/or delivery fee and the restaurant receives the balance of the customer payment.

However, one drawback to these online delivery services is that, when placing an order, the customer's choices are limited to the menu items available on the menu of the selected restaurant. In other words, the customer, by having to first select a particular restaurant before selecting menu items, is limited to the menu and, by extension, the particular cuisine (e.g., Italian, Chinese, Mexican, etc.) offered by the selected restaurant. Thus, a customer who desires to place a single delivery order containing a combination of menu items from different cuisines (e.g., a single order containing an Italian dish, a Chinese dish, and a Mexican dish) cannot do so using the ordering systems currently operated by the online delivery services. Accordingly, there is need for a solution to this problem.

This problem is solved by the methods and systems of the present invention, as disclosed and claimed herein.

### EMBODIMENTS OF THE INVENTION

An embodiment of the present invention is a computer-implemented method for ordering food for delivery comprising receiving a food order comprising at least one menu item from a user communication device over a communication network, wherein the at least one menu item is selected from a menu comprising at least two different pre-determined cuisine categories, transmitting the received food order to a food delivery service over a communication network, and transmitting the received food order over a communication network to a kitchen for preparation and packaging for subsequent acquisition by a delivery agent, wherein the kitchen is configured to prepare the at least one menu item ordered from the menu comprising at least two different pre-determined cuisine categories. In certain embodiments of this computer-implemented method, the delivery agent is associated with and/or dispatched by the food delivery service. In certain embodiments of this computer-implemented method, the method further comprises receiving confirmation from the food delivery service over a communication network that the received food order transmitted thereto was received. In certain embodiments of this computer-implemented method, the method further comprises determining a location of the user communication device connected over a communication network, wherein the menu comprising at least two different pre-determined cuisine categories is determined based on the determined location of the user communication device. In certain embodiments of this computer-implemented method, the food order comprises at least two menu items selected from a menu comprising at least two different pre-determined cuisine categories, at least two of said at least two menu items are selected from different pre-determined cuisine categories, and the kitchen is configured to prepare the at least two menu items ordered from the menu comprising at least two different pre-determined cuisine categories.

Another embodiment of the present invention is a computer-implemented method for ordering food for delivery comprising receiving a food order comprising at least one menu item from a user communication device over a communication network, wherein the at least one menu item is selected from a menu comprising at least two different pre-determined cuisine categories, transmitting the received food order to a food delivery service over a communication network, associating the at least one menu item of the food order with a pre-determined cuisine category, creating at least one sub-order based on the pre-determined cuisine category to which said at least one menu item is associated, and routing the at least one sub-order over a communication network to a kitchen for preparation and packaging for subsequent acquisition by a delivery agent, wherein the at least one sub-order is routed to a kitchen configured to prepare menu items from the pre-determined cuisine category associated with the at least one sub-order. In certain embodiments of this computer-implemented method, the delivery agent is associated with and/or dispatched by the food delivery service. In certain embodiments of this computer-implemented method, the method further comprises receiving confirmation from the food delivery service over a communication network that the received order transmitted thereto was received. In certain embodiments of this computer-implemented method, the method further comprises determining a location of the user communication device connected over a communication network; wherein the menu comprising at least two different pre-determined cuisine categories is determined based on the determined location of the user communication device. In certain embodiments of this computer-implemented method, the food order comprises at least two menu items selected from a menu comprising at least two different pre-determined cuisine categories, wherein at least two of said at least two menu items are selected from different pre-determined cuisine categories, each of the at least two menu items of the food order are associated with a pre-determined cuisine category, at least two sub-orders are created based on the pre-determined cuisine category to which each of the at least two menu items are associated, when at least two menu items are associated with the same pre-determined cuisine category, said at least two menu items associated with the same pre-determined cuisine category are combined into a single sub-order, and the at least two sub-orders are routed over a communication network to a kitchen for preparation and packaging for subsequent acquisition by a delivery agent, wherein each of the at least two sub-orders is routed to a kitchen configured to prepare menu items from the pre-determined cuisine category associated with the sub-order routed thereto.

Another embodiment of the present invention is a computer-implemented method for ordering a food order for delivery comprising receiving a food order comprising at least one menu item from a food delivery service over a communication network, wherein the at least one menu item is selected from a menu comprising at least two different pre-determined cuisine categories and transmitting the received food order over a communication network to a kitchen for preparation and packaging for subsequent acquisition by a delivery agent, wherein the kitchen is configured to prepare the at least one menu item ordered from the menu comprising at least two different pre-determined cuisine categories. In certain embodiments of this computer-implemented method, the food order comprises at least two menu items selected from a menu comprising at least two different pre-determined cuisine categories, at least two of said at least two menu items are selected from different pre-determined cuisine categories, and the kitchen is configured to prepare the at least two menu items ordered from the menu comprising at least two different pre-determined cuisine categories. In certain embodiments of this computer-implemented method, the delivery agent is associated with and/or dispatched by the food delivery service.

Another embodiment of the present invention is a computer-implemented method for ordering a food order for delivery comprising receiving a food order comprising at least one menu item from a food delivery service over a communication network, wherein the at least one menu item is selected from a menu comprising at least two different pre-determined cuisine categories, associating the at least one menu item of the food order with a pre-determined cuisine category, creating at least one sub-order based on the pre-determined cuisine category to which said at least one menu item is associated, and routing the at least one sub-order over a communication network to a kitchen for preparation and packaging for subsequent acquisition by a delivery agent, wherein the at least one sub-order is routed to a kitchen configured to prepare menu items from the pre-determined cuisine category associated with the at least one sub-order. In certain embodiments of this computer-implemented method, the food order comprises at least two menu items selected from a menu comprising at least two different pre-determined cuisine categories, wherein at least two of said at least two menu items are selected from different pre-determined cuisine categories; each of the at least two menu items of the food order are associated with a pre-determined cuisine category, at least two sub-orders are created based on the pre-determined cuisine category to which each of the at least two menu items are associated, when at least two menu items are associated with the same pre-determined cuisine category, said at least two menu items associated with the same pre-determined cuisine category are combined into a single sub-order, and the at least two sub-orders are routed over a communication network to a kitchen for preparation and packaging for subsequent acquisition by a delivery agent, wherein each of the at least two sub-orders is routed to a kitchen configured to prepare menu items from the pre-determined cuisine category associated with the sub-order routed thereto. In certain embodiments of this computer-implemented method, the delivery agent is associated with and/or dispatched by the food delivery service.

Another embodiment of the present invention is a system for providing an interactive service for ordering food for delivery accessible by a user communication device, the system comprising at least one server configured to receive a food order comprising at least one menu item from a user communication device over a communication network, wherein the at least one menu item is selected from a menu comprising at least two different pre-determined cuisine categories, transmit the received food order to a food delivery service over a communication network, and transmit the received food order over a communication network to a kitchen for preparation and packaging for subsequent acquisition by a delivery agent, wherein the kitchen is configured to prepare the at least one menu item ordered from the menu comprising at least two different pre-determined cuisine categories.

Another embodiment of the present invention is a system for providing an interactive service for ordering food for delivery accessible by a user communication device, the system comprising at least one server configured to receive a food order comprising at least one menu item from a user communication device over a communication network, wherein the at least one menu item is selected from a menu comprising at least two different pre-determined cuisine categories, transmit the received food order to a food delivery service over a communication network; associate the at least one menu item of the food order with a pre-determined cuisine category, create at least one sub-order based on the pre-determined cuisine category to which said at least one menu item is associated; and route the at least one sub-order over a communication network to a kitchen for preparation and packaging for subsequent acquisition by a delivery agent, wherein the at least one sub-order is routed to a kitchen configured to prepare menu items from the pre-determined cuisine category associated with the at least one sub-order.

Another embodiment of the present invention is a system for providing an interactive service for ordering food for delivery accessible by a user communication device, the system comprising at least one server configured to receive a food order comprising at least one menu item from a food delivery service over a communication network, wherein the at least one menu item is selected from a menu comprising at least two different pre-determined cuisine categories, and transmit the received food order over a communication network to a kitchen for preparation and packaging for subsequent acquisition by a delivery agent, wherein the kitchen is configured to prepare the at least one menu item ordered from the menu comprising at least two different pre-determined cuisine categories.

Another embodiment of the present invention is a system for providing an interactive service for ordering food for delivery accessible by a user communication device, the system comprising at least one server configured to receive a food order comprising at least one menu item from a food delivery service over a communication network, wherein the at least one menu item is selected from a menu comprising at least two different pre-determined cuisine categories, associate the at least one menu item of the order with a pre-determined cuisine category; create at least one sub-order based on the pre-determined cuisine category to which said at least one menu item is associated, and route the at least one sub-order over a communication network to a kitchen for preparation and packaging for subsequent acquisition by a delivery agent, wherein the at least one sub-order is routed to a kitchen configured to prepare menu items from the pre-determined cuisine category associated with the at least one sub-order.

The foregoing embodiments are illustrative only and are not intended to be in any way limiting. In addition to the illustrative aspects, embodiments, and features described above, further aspects, embodiments, and features will become apparent by reference to the following detailed description.

### BRIEF DESCRIPTION OF THE FIGURES

The foregoing, as well as the following detailed description of the invention, will be better understood when read in conjunction with the appended figures. It should be understood, however, that the present invention is not limited to the precise arrangements and instrumentalities shown.

FIG. 1 depicts an embodiment of the methods and systems according to the present invention.

FIG. 2 depicts an embodiment of the methods and systems according to the present invention.

FIG. 3 depicts an embodiment of the methods and systems according to the present invention.

FIG. 4 depicts an embodiment of the methods and systems according to the present invention.

### DETAILED DESCRIPTION OF THE INVENTION

Unless otherwise defined, all technical and scientific terms used herein have the same meaning as commonly understood by one of ordinary skill in the art to which this invention belongs. Although methods, materials, and/or components similar or equivalent to those described herein can be used in the practice or testing of the invention, suitable methods, materials, and/or components are described below. All publications, patent applications, patents, and other references mentioned herein are incorporated by reference in their entirety. In the case of conflict, the present specification, including definitions, will control. The use of the terms “a” and “an” and “the” and similar referents in the context of describing the elements (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

One aspect of the present invention is directed to computer-implemented methods for ordering food for delivery.

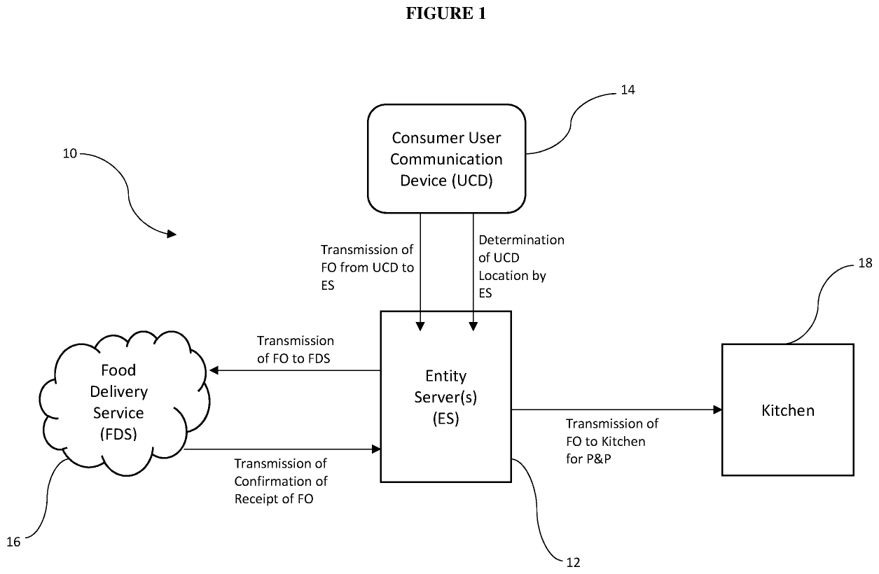

In one embodiment of such methods according to the present invention, and referring now to FIG. 1, a food order comprising at least one menu item is transmitted over a communication network from a user communication device 14 to, and is received by, one or more servers 12 operated and maintained by, and optionally owned by, an entity. As used herein, the term “food order” includes orders of food, beverages, and any combination thereof.

The food orders of the methods and systems according to the present invention can comprise any number of menu items selected from a menu comprising at least two different pre-determined cuisine categories and comprise at least one menu item. In certain embodiments of the methods and systems according to the present invention, the food order comprises at least two, at least three, at least four, at least five, at least six, at least seven, at least eight, at least nine, or at least ten menu items selected from a menu comprising at least two different pre-determined cuisine categories. In certain embodiments of the methods and systems according to the present invention, the food order comprises at least two menu items selected from a menu comprising at least two different pre-determined cuisine categories, at least two, at least three, at least four, at least five, at least six, at least seven, at least eight, at least nine, or at least ten of which are selected from different pre-determined cuisine categories.

The menu items of the methods and systems according to the present invention are selected from a menu comprising at least one pre-determined cuisine category. The pre-determined cuisine categories of the methods and systems according to the present invention, can include, but are not limited to, American cuisines (e.g., burgers, pizza, barbecue, etc.), Mexican cuisines, Asian cuisines (e.g., Chinese cuisines, Japanese cuisines (e.g., sushi), Korean cuisines, Vietnamese cuisines, Thai cuisines, etc.), Indian cuisines, European cuisines (e.g., Italian cuisines (e.g., pasta), French cuisines, Spanish cuisines, German cuisines, etc.), Mediterranean cuisines (e.g., Lebanese cuisines, Moroccan cuisines, Greek cuisines, Turkish cuisines, etc.), Cajun cuisine, Creole cuisine, Cuban cuisines, Caribbean cuisines, soul food, seafood, organic cuisines, diet cuisines, gluten free cuisines, and baked goods. In certain embodiments of the methods and systems according to the present invention, the menu comprises at least two, at least three, at least four, at least five, at least six, at least seven, at least eight, at least nine, or at least ten different pre-determined cuisine categories. In further embodiments of the methods and systems according to the present invention, the menu comprises at least one pre-determined cuisine category that represents a rebranding of the cuisine currently offered by the establishment.

The communication networks of the methods and systems according to the present invention can be any network. In certain embodiments of the methods and systems according to the present invention, the communication network is the internet. In certain embodiments of the methods and systems according to the present invention, the communication network may be a single network or a combination of networks, including parts of an Ethernet, LAN, WAN, WiFi, or WiMax network, a wireless network, an optical network, a cellular network, a global network, a Public Switch Telephone Network (PTSN), or a fiber optic network.

The user communication devices of the methods and systems according to the present invention can be any user communication device. In certain embodiments of the methods and systems according to the present invention, the user communication devices can be a desktop computer, a laptop computer, a smartphone, or a tablet configured to have access to a network, such as the internet, via a web browser application or an application programming interface (API) so as to be able to connect and communicate with the one or more servers via a website or application hosted by at least one of the one or more servers.

Using the user communication device, a customer selects at least one menu item from a menu comprising at least two different pre-determined cuisine categories, which is populated on a website or application hosted by at least one of the one or more servers. In certain embodiments of the methods and systems according to the present invention, the geographic location of the user communication device can be determined by at least one of the one or more servers. In certain embodiments of the methods and systems according to the present invention, the geographic location of the user communication device is inputted by the user into a website or application hosted by at least one of the one or more servers. In certain embodiments of the methods and systems according to the present invention, the geographic location of the user communication device is automatically detected (e.g., from the GPS functionality of a smart phone) by an application or website hosted by at least one of the one or more servers. In certain embodiments of the methods and systems according to the present invention, the menu comprising at least two different pre-determined cuisine categories is determined and populated based on the determined location of the user communication device and the availability of kitchens within a pre-determine delivery area or radius that are configured to prepare and package menu items from the populated menu.

In certain embodiments of the methods and systems according to the present invention, the user (e.g., customer) can register with the entity as a member of a loyalty rewards program, as well as to receive flash and holiday coupons. In doing so, the user can earn rewards based on, for example, purchasing a food order having a minimum dollar value (e.g., $40), which, for example, can be redeemed within a certain time period (e.g., 120 days, with reminders sent to the user at 30 days from expiration). In certain embodiments of the methods and systems according to the present invention, the rewards can either be redeemed for a coupon value or a cash value. In certain embodiments of the methods and systems according to the present invention, the coupons can be redeemed for a certain, minimum amount, (e.g., coupon increments of $5). In certain embodiments of the methods and systems according to the present invention, the rewards can be based on a percentage of the dollar value of the order, with the option of the percentage increasing as the minimum dollar value of the purchase amount of the food order increases. For example, for purchased food orders having a dollar value in the range of from $40.00 to $99.99, the coupon rewards are calculated as 10% of the value of the dollar value of the purchased food orders, while the cash rewards are calculated as 1% of the value of the dollar value of the purchased food orders. When the dollar value of the purchased food orders falls within the range of from $100.00 to $249.99, the coupon rewards are calculated as 20% of the value of the dollar value of the purchased food orders, while the cash rewards are calculated as 2% of the value of the dollar value of the purchased food orders. When the dollar value of the purchased food orders falls above $250.00, the coupon rewards are calculated as 30% of the value of the dollar value of the purchased food orders, while the cash rewards are calculated as 3% of the value of the dollar value of the purchased food orders. Alternatively, the respective values of the coupon rewards and the cash rewards can be calculated at different percentages, e.g., when the dollar value of the purchased food orders falls within the range of from $80.00 to $99.99, the coupon rewards are calculated as 10% of the value of the dollar value of the purchased food orders, while the cash rewards are calculated as 2% of the value of the dollar value of the purchased food orders. In certain embodiments of the methods and systems according to the present invention, the user can redeem the coupon rewards with an establishment (e.g., a kitchen or restaurant) partnered with the entity that operates, maintains, and optionally owns, the one or more servers, whereby the coupon bar code is scanned and entered at the partner establishment. In certain embodiments of the methods and systems according to the present invention, the user can redeem the cash rewards entity that operates, maintains, and optionally owns, the one or more servers or online or in person at an establishment (e.g., a kitchen or restaurant) partnered with the entity that operates, maintains, and optionally owns, the one or more servers or online through applications like Zelle, Venmo, or Paypal. In certain embodiments of the methods and systems according to the present invention, the entity that operates, maintains, and optionally owns, the one or more servers can reduce the delivery fee charged if the sale in generated through the entity's website rather than that of the delivery service, which is advantageous to the user and the establishment.

Referring again to FIG. 1, the received food order is transmitted over a communication network from the one or more servers 12 to, and is received by, a food delivery service 16.

In certain embodiments of the methods and systems according to the present invention, the received food order is transmitted to, and is received by, a website or web-based portal or application hosted by one or more servers operated and maintained by, and optionally owned by, a food delivery service. In certain embodiments of the methods and systems according to the present invention, the food delivery service can transmit over a communication network a confirmation that the received food order transmitted to food delivery service was received, and which can be received by, at least one of the one or more servers operated and maintained by and optionally owned by, an entity. In certain embodiments of the methods and systems according to the present invention, this confirmation can take the form of an electronic receipt. In certain embodiments of the methods and systems according to the present invention, this confirmation can be a transmission of the food order transmitted to food delivery service.

The food delivery services of the methods and systems according to the present invention can be any known online food delivery service. In certain embodiments of the methods and systems according to the present invention, the food delivery services of the methods and systems according to the present invention can be Uber Eats™, GrubHub™, Seamless™, Postmates™, DoorDash™, Delivery.com™, Eat24™, Caviar™, and Beyond Menu™.

Referring again to FIG. 1, the received food order is also transmitted over a communication network from the one or more servers 12 to, and is received by, a kitchen 18 for preparation and packaging for subsequent acquisition by a delivery agent. In certain embodiments of the methods and systems according to the present invention, the kitchen 18 is configured to prepare the at least one menu item ordered from the menu comprising at least two different pre-determined cuisine categories. In certain embodiments of the methods and systems according to the present invention, the kitchen 18 is configured to prepare the at least two, at least three, at least four, at least five, at least six, at least seven, at least eight, at least nine, or at least ten menu items ordered from the menu comprising at least two different pre-determined cuisine categories. In certain embodiments of the methods and systems according to the present invention, the kitchen 18 is configured to prepare all of menu items listed on the menu comprising at least two different pre-determined cuisine categories.

The kitchens of the methods and systems according to the present invention can be any suitable kitchen. In certain embodiments of the methods and systems according to the present invention, the kitchen is constructed, configured, and dedicated to only prepare and package some or all of the menu items listed on the menu comprising at least two different pre-determined cuisine categories. In certain embodiments of the methods and systems according to the present invention, the kitchen is configured to prepare and package some or all of the menu items listed on the menu comprising at least two different pre-determined cuisine categories, but also operates independently as a kitchen and/or restaurant. In such embodiments, the cuisine or cuisines offered and prepared by the kitchen and/or restaurant in its independent operation can be the same as or different from the cuisine or cuisines its offers and prepares for the menu comprising at least two different pre-determined cuisine categories. In certain embodiments of the methods and systems according to the present invention, the kitchen operates independently, but is a partner with the entity that operates, maintains, and optionally owns the one or more servers. Persons of ordinary skill in the art will recognize that an advantage to the methods and systems according to the present invention is the potential for such partners to generate additional revenue through the sale of additional food product that can be categorized as a cuisine that is the same as or different from the cuisine or cuisines its offers and prepares in its independent operation. In certain embodiments of the methods and systems according to the present invention, the kitchen may offer a dining room service in addition to a take-out and/or delivery service. In certain embodiments of the methods and systems according to the present invention, the kitchen may offer a take-out and/or delivery service only. In certain embodiments of the methods and systems according to the present invention, the kitchen may offer a delivery service only. Persons of ordinary skill in the art will recognize that an advantage to the methods and systems according to the present invention for such partners is the potential elimination of the excess financial overhead required to maintain a dining room service, i.e., the additional costs related to labor, utilities, insurance, and to rent, purchase, or build additional floor space, and, in the context of providing a delivery service only, the excess financial overhead required to maintain a point-of-sale presence.

In certain embodiments of the methods and systems according to the present invention, the delivery agent is a person associated with and/or dispatched by the food delivery service. In certain embodiments of the methods and systems according to the present invention, the delivery agent is a person associated with and/or dispatched by the kitchen. In certain embodiments of the methods and systems according to the present invention, the delivery agent is a person associated with and/or dispatched by the entity that operates and maintains, and optionally owns, the one or more servers.

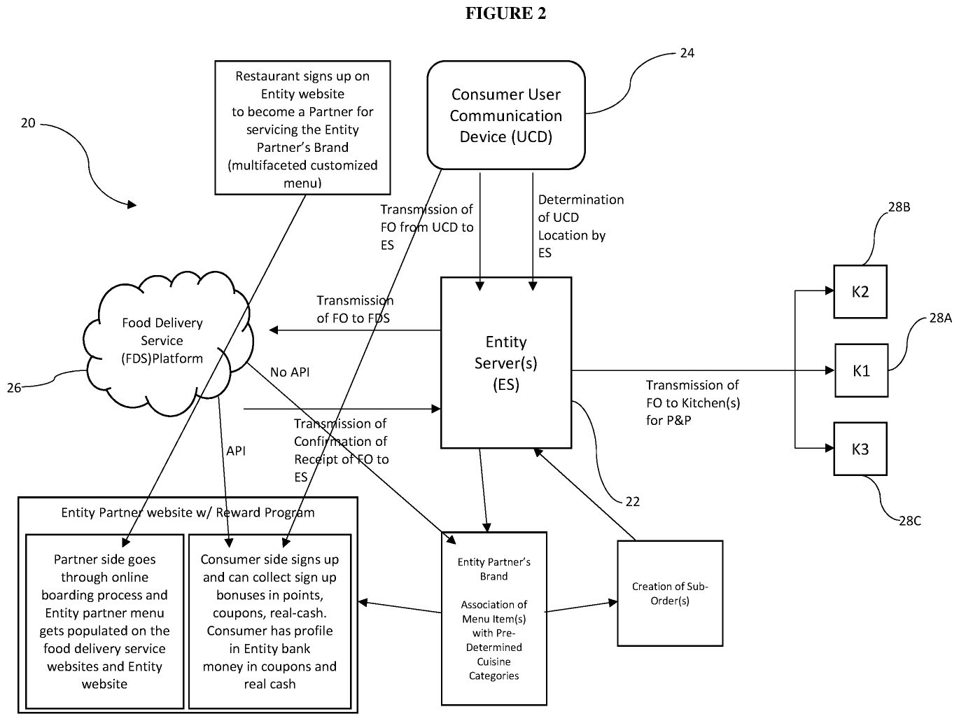

In another embodiment of such methods according to the present invention, and referring now to FIG. 2, a food order comprising at least one menu item is transmitted over a communication network from a user communication device 24 to, and is received by, one or more servers 22 operated and maintained by, and optionally owned by, an entity. The at least one menu item is selected from a menu comprising at least two different pre-determined cuisine categories. The received food order is transmitted over a communication network from the one or more servers 22 to, and is received by, a food delivery service 26. Each of the at least one menu items of the food order are associated with a pre-determined cuisine category. One or more sub-orders based on the pre-determined cuisine category is then created, to which said at least one menu item is associated. Each sub-order is routed over a communication network from the one or more servers 22 to, and is received by, one or more kitchens, e.g., 28A, 28B, and/or 28C for preparation and packaging for subsequent acquisition by a delivery agent. Each kitchen to which a sub-order is routed is configured to prepare menu items from the pre-determined cuisine category associated with the sub-order routed thereto.

In certain embodiments of this method according to the present invention, the food order comprises at least two menu items selected from a menu comprising at least two different pre-determined cuisine categories, wherein at least two of said at least two menu items are selected from different pre-determined cuisine categories. Each of the at least two menu items of the food order are associated with a pre-determined cuisine category. At least two sub-orders are then created based on the pre-determined cuisine category to which each of the at least two menu items are associated. In instances when at least two menu items are associated with the same pre-determined cuisine category, these menu items are combined into a single sub-order. Each of the at least two sub-orders are then routed over a communication network to a kitchen for preparation and packaging for subsequent acquisition by a delivery agent. Each kitchen to which each of the at least two sub-orders is routed is configured to prepare menu items from the pre-determined cuisine category associated with the sub-order routed thereto.

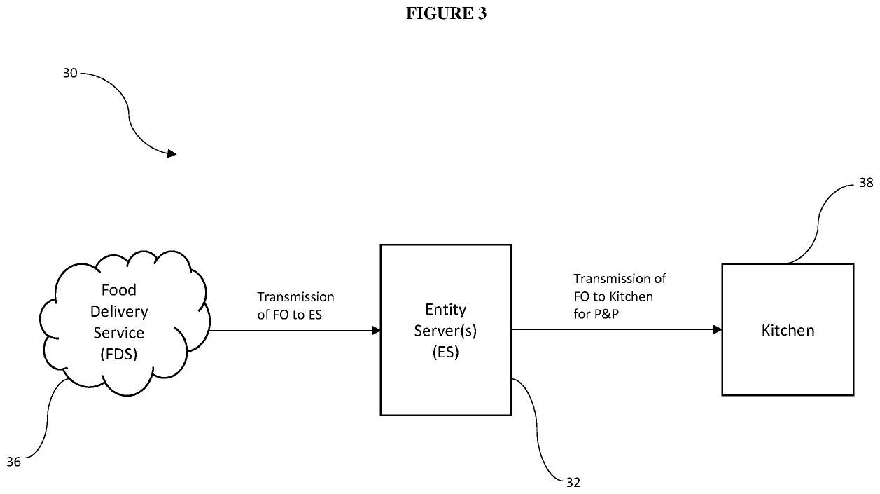

In another embodiment of such methods according to the present invention, and referring now to FIG. 3, a food order comprising at least one menu item is transmitted over a communication network from a food delivery service 36 to, and is received by, one or more servers 32 operated and maintained by, and optionally owned by, an entity. The at least one menu item is selected from a menu comprising at least two different pre-determined cuisine categories. The menu comprising at least two different pre-determined cuisine categories is populated on the website maintained by the food delivery service. The received food order is then transmitted over a communication network from the one or more servers 32 to, and is received by, a kitchen 38 for preparation and packaging for subsequent acquisition by a delivery agent, wherein the kitchen is configured to prepare the at least one menu item ordered from the menu comprising at least two different pre-determined cuisine categories.

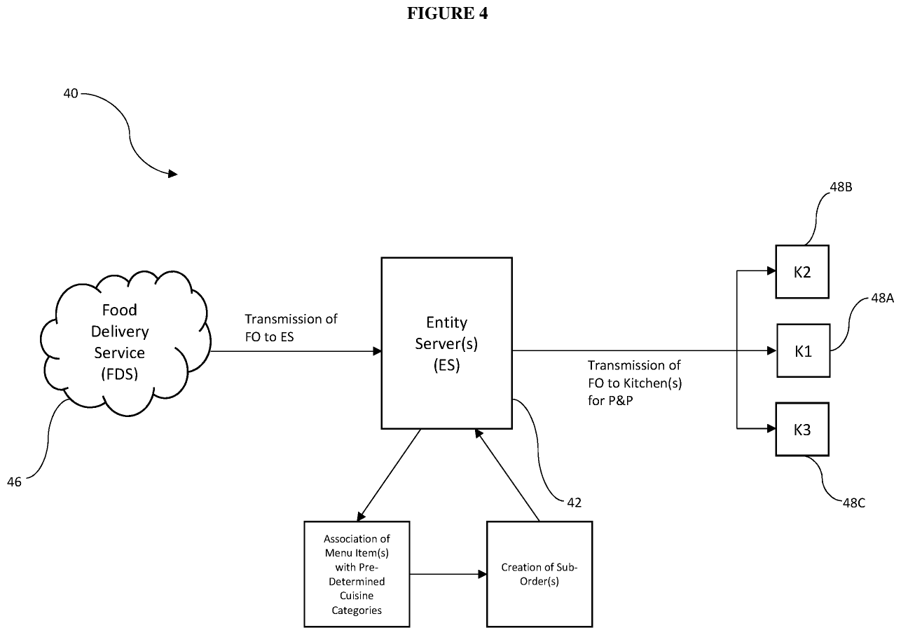

In another embodiment of such methods according to the present invention, and referring now to FIG. 4, a food order comprising at least one menu item is transmitted over a communication network from a food delivery service 46 to, and is received by, one or more servers 42 operated and maintained by, and optionally owned by, an entity. The at least one menu item is selected from a menu comprising at least two different pre-determined cuisine categories. The menu comprising at least two different pre-determined cuisine categories is populated on the website maintained by the food delivery service. Each of the at least one menu items of the food order are associated with a pre-determined cuisine category. One or more sub-orders based on the pre-determined cuisine category is then created, to which said at least one menu item is associated. Each sub-order is routed over a communication network from the one or more servers 42 to, and is received by, one or more kitchens, e.g., 48A, 48B, and/or 48C for preparation and packaging for subsequent acquisition by a delivery agent. Each kitchen to which a sub-order is routed is configured to prepare menu items from the pre-determined cuisine category associated with the sub-order routed thereto.

In certain embodiments of this method according to the present invention, the food order comprises at least two menu items selected from a menu comprising at least two different pre-determined cuisine categories, wherein at least two of said at least two menu items are selected from different pre-determined cuisine categories. Each of the at least two menu items of the food order are associated with a pre-determined cuisine category. At least two sub-orders are then created based on the pre-determined cuisine category to which each of the at least two menu items are associated. In instances when at least two menu items are associated with the same pre-determined cuisine category, these menu items are combined into a single sub-order. Each of the at least two sub-orders are then routed over a communication network to a kitchen for preparation and packaging for subsequent acquisition by a delivery agent. Each kitchen to which each of the at least two sub-orders is routed is configured to prepare menu items from the pre-determined cuisine category associated with the sub-order routed thereto.

Another aspect of the present invention is directed to systems for providing an interactive service for ordering food for delivery accessible by a user communication device.

Referring again to FIG. 1, in certain embodiments of the methods and systems according to the present invention, such systems comprise at least one server 12 configured to receive a food order comprising at least one menu item from a user communication device over a communication network, wherein the at least one menu item is selected from a menu comprising at least two different pre-determined cuisine categories, transmit the received food order to a food delivery service over a communication network, and transmit the received food order over a communication network to a kitchen for preparation and packaging for subsequent acquisition by a delivery agent, wherein the kitchen is configured to prepare the at least one menu item ordered from the menu comprising at least two different pre-determined cuisine categories.

Referring again to FIG. 2, in certain embodiments of the methods and systems according to the present invention, such systems comprise at least one server 22 configured to receive a food order comprising at least one menu item from a user communication device over a communication network, wherein the at least one menu item is selected from a menu comprising at least two different pre-determined cuisine categories, transmit the received food order to a food delivery service over a communication network, associate the at least one menu item of the food order with a pre-determined cuisine category, create at least one sub-order based on the pre-determined cuisine category to which said at least one menu item is associated, and route the at least one sub-order over a communication network to a kitchen for preparation and packaging for subsequent acquisition by a delivery agent, wherein the at least one sub-order is routed to a kitchen configured to prepare menu items from the pre-determined cuisine category associated with the at least one sub-order.

Referring again to FIG. 3, in certain embodiments of the methods and systems according to the present invention, such systems comprise at least one server 32 configured to receive a food order comprising at least one menu item from a food delivery service over a communication network, wherein the at least one menu item is selected from a menu comprising at least two different pre-determined cuisine categories, and transmit the received food order over a communication network to a kitchen for preparation and packaging for subsequent acquisition by a delivery agent, wherein the kitchen is configured to prepare the at least one menu item ordered from the menu comprising at least two different pre-determined cuisine categories.

Referring again to FIG. 4, in certain embodiments of the methods and systems according to the present invention, such systems comprise at least one server 42 configured to receive a food order comprising at least one menu item from a food delivery service over a communication network, wherein the at least one menu item is selected from a menu comprising at least two different pre-determined cuisine categories, associate the at least one menu item of the order with a pre-determined cuisine category, create at least one sub-order based on the pre-determined cuisine category to which said at least one menu item is associated, and route the at least one sub-order over a communication network to a kitchen for preparation and packaging for subsequent acquisition by a delivery agent, wherein the at least one sub-order is routed to a kitchen configured to prepare menu items from the pre-determined cuisine category associated with the at least one sub-order.

The processing of food orders for delivery can be challenging because the systems and methods disclosed herein can be configured to work with hundreds or thousands of websites, each with hundreds or thousands of simultaneous web users. Therefore, the systems herein must be configured to process and manage thousands or millions of food orders, menus, and cuisine categories simultaneously. In an embodiment, the systems can be configured to process food orders from various websites once every 1 second, 2 seconds, 3 seconds, 4 seconds, or 5 seconds. The sheer volume of data coming into the systems makes it impossible for a human being, whether entirely in the person's mind or whether the person is using a pen and paper, to track and/or perform, in real-time or substantially real-time (for example, within 1 to 30 seconds, or within 1 second to 1 minute), the activities of the embodiments of the systems and methods disclosed herein. Similarly, it is impossible for a human being, whether entirely in the person's mind or whether the person is using a pen and paper, to process in real-time or substantially real time (for example, within 1 to 30 seconds) for hundreds or thousands of simultaneous food orders a customer's selection of one or more menu items such that the order is properly transmitted to at least one associated kitchen for preparation of the at least one menu item.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although several embodiments, examples and illustrations have been disclosed herein, it will be understood by those of ordinary skill in the art that the inventions described herein extend beyond the specifically disclosed embodiments, examples, and illustrations, and include other uses of the inventions and obvious modifications and equivalents thereof. Embodiments of the inventions have been described with reference to the accompanying figures, wherein like numerals refer to like elements throughout. The terminology used in the description presented herein is not intended to be interpreted in any limiting or restrictive manner simply because it has been used in conjunction with a detailed description of certain specific embodiments of the inventions. In addition, embodiments of the inventions can comprise several novel features and no single feature is solely responsible for its desirable attributes or is essential to practicing the inventions herein described.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject application as defined by the appended claims.

1. A computer-implemented method for ordering food for delivery comprising:
receiving a food order comprising at least one menu item from a user communication device over a communication network, wherein the at least one menu item is selected from a menu comprising at least two different pre-determined cuisine categories;
transmitting the received food order to a food delivery service over a communication network; and
transmitting the received food order over a communication network to a kitchen for preparation and packaging for subsequent acquisition by a delivery agent, wherein the kitchen is configured to prepare the at least one menu item ordered from the menu comprising at least two different pre-determined cuisine categories.

2. The computer-implemented method of claim 1, wherein the delivery agent is associated with and/or dispatched by the food delivery service.

3. The computer-implemented method of claim 1, further comprising:
receiving confirmation from the food delivery service over a communication network that the received food order transmitted thereto was received.

4. The computer-implemented method of claim 1, further comprising:
determining a location of the user communication device connected over a communication network;
wherein the menu comprising at least two different pre-determined cuisine categories is determined based on the determined location of the user communication device.

5. The computer-implemented method of claim 1, wherein the food order comprises at least two menu items selected from a menu comprising at least two different pre-determined cuisine categories, at least two of said at least two menu items are selected from different pre-determined cuisine categories, and the kitchen is configured to prepare the at least two menu items ordered from the menu comprising at least two different pre-determined cuisine categories.

6. A computer-implemented method for ordering food for delivery comprising:
receiving a food order comprising at least one menu item from a user communication device over a communication network, wherein the at least one menu item is selected from a menu comprising at least two different pre-determined cuisine categories;
transmitting the received food order to a food delivery service over a communication network;
associating the at least one menu item of the food order with a pre-determined cuisine category;
creating at least one sub-order based on the pre-determined cuisine category to which said at least one menu item is associated; and
routing the at least one sub-order over a communication network to a kitchen for preparation and packaging for subsequent acquisition by a delivery agent, wherein the at least one sub-order is routed to a kitchen configured to prepare menu items from the pre-determined cuisine category associated with the at least one sub-order.

7. The computer-implemented method of claim 6, wherein the delivery agent is associated with and/or dispatched by the food delivery service.

8. The computer-implemented method of claim 6, further comprising:
receiving confirmation from the food delivery service over a communication network that the received order transmitted thereto was received.

9. The computer-implemented method of claim 6, further comprising:
determining a location of the user communication device connected over a communication network;
wherein the menu comprising at least two different pre-determined cuisine categories is determined based on the determined location of the user communication device.

10. The computer-implemented method of claim 6, wherein:
the food order comprises at least two menu items selected from a menu comprising at least two different pre-determined cuisine categories, wherein at least two of said at least two menu items are selected from different pre-determined cuisine categories;
each of the at least two menu items of the food order are associated with a pre-determined cuisine category;
at least two sub-orders are created based on the pre-determined cuisine category to which each of the at least two menu items are associated;
when at least two menu items are associated with the same pre-determined cuisine category, said at least two menu items associated with the same pre-determined cuisine category are combined into a single sub-order; and
the at least two sub-orders are routed over a communication network to a kitchen for preparation and packaging for subsequent acquisition by a delivery agent, wherein each of the at least two sub-orders is routed to a kitchen configured to prepare menu items from the pre-determined cuisine category associated with the sub-order routed thereto.

11. A computer-implemented method for ordering food for delivery comprising:
receiving a food order comprising at least one menu item from a food delivery service over a communication network, wherein the at least one menu item is selected from a menu comprising at least one pre-determined cuisine category; and
transmitting the received food order over a communication network to a kitchen for preparation and packaging for subsequent acquisition by a delivery agent, wherein the kitchen is configured to prepare the at least one menu item ordered from the menu comprising at least one pre-determined cuisine category.

12. The computer-implemented method of claim 11, wherein the food order comprises at least two menu items selected from a menu comprising at least two different pre-determined cuisine categories, at least two of said at least two menu items are selected from different pre-determined cuisine categories, and the kitchen is configured to prepare the at least two menu items ordered from the menu comprising at least two different pre-determined cuisine categories.

13. The computer-implemented method of claim 11, wherein the delivery agent is associated with and/or dispatched by the food delivery service.

14. A computer-implemented method for ordering food for delivery comprising:
receiving a food order comprising at least one menu item from a food delivery service over a communication network, wherein the at least one menu item is selected from a menu comprising at least two different pre-determined cuisine categories;
associating the at least one menu item of the food order with a pre-determined cuisine category;
creating at least one sub-order based on the pre-determined cuisine category to which said at least one menu item is associated; and
routing the at least one sub-order over a communication network to a kitchen for preparation and packaging for subsequent acquisition by a delivery agent, wherein the at least one sub-order is routed to a kitchen configured to prepare menu items from the pre-determined cuisine category associated with the at least one sub-order.

15. The computer-implemented method of claim 14, wherein:
the food order comprises at least two menu items selected from a menu comprising at least two different pre-determined cuisine categories, wherein at least two of said at least two menu items are selected from different pre-determined cuisine categories;
each of the at least two menu items of the food order are associated with a pre-determined cuisine category;
at least two sub-orders are created based on the pre-determined cuisine category to which each of the at least two menu items are associated;
when at least two menu items are associated with the same pre-determined cuisine category, said at least two menu items associated with the same pre-determined cuisine category are combined into a single sub-order; and
the at least two sub-orders are routed over a communication network to a kitchen for preparation and packaging for subsequent acquisition by a delivery agent, wherein each of the at least two sub-orders is routed to a kitchen configured to prepare menu items from the pre-determined cuisine category associated with the sub-order routed thereto.

16. The computer-implemented method of claim 14, wherein the delivery agent is associated with and/or dispatched by the food delivery service.
